(19) United States
(12) Patent Application Publication
(10) Pub. No.: US 2016/0346158 A1
(43) Pub. Date: Dec. 1, 2016

(54) MASSAGE DEVICE FOR TILTING INVERSION EXERCISER

(71) Applicants: Expectations, LLC, Puyallup, WA (US); Beto Engineering & Marketing Co., Ltd., Taichung (TW)

(72) Inventors: Christopher Henry Leier, Taichung, WA (US); Lo Pin WANG, Taichung (TW)

(21) Appl. No.: 14/724,962

(22) Filed: May 29, 2015

(51) Int. Cl. A61H 7/00

(52) U.S. Cl. CPC A61H 7/001

(57) ABSTRACT

A tilting inversion exerciser includes a carrier attached to a supporting stand for mounting a supporting table, the supporting table includes a number of grooves, and a massage member is engaged with either of the grooves of the supporting table for attaching to the supporting table and for massaging the user. The massage member includes a block having a screw hole for engaging with the supporting table, and a threaded shank extended from a knob for engaging through either of the grooves of the supporting table and for engaging with the screw hole of the block and for detachably securing the massage member to the supporting table at selected positions.

### BACKGROUND OF THE INVENTION

1. Field of the Invention

The present invention relates to a tilting inversion exerciser, and more particularly to a tilting inversion exerciser including a massage device or mechanism for massaging the back portions of the user in addition to the rotational exercises.

2. Description of the Prior Art

Various kinds of typical inversion suspension exercisers, rotational exercisers, tilting inversion exercisers etc. have been developed and comprise a table rotatably or pivotally attached to an upper portion of a lower or base support with a pivot axle, and rotatable relative to the base support for conducting various inversion or suspension exercises.

For example, U.S. Pat. No. 7,052,448 to Teeter, and U.S. Pat. No. 7,361,128 to Chen disclose two of the typical inversion suspension exercisers each comprising a table rotatably or pivotally attached to a base support with a hanger bar, for allowing the users to rotate the table relative to the base support, and to do various inversion or suspension exercises.

However, the table of the typical inversion suspension exercisers may only be used to support the back portions of the users, and the typical inversion suspension exercisers do not have any massage members or devices to massage the back portions of the users, such that the users may use the conventional tilting inversion exercisers to conduct only the rotational or inversion exercises.

U.S. Patent Application No. 2006/0063654 to Kuo discloses another typical inversion suspension exerciser comprising a table rotatably or pivotally attached to a base support with a hanger bar, for allowing the users to rotate the table relative to the base support, and to do various inversion or suspension exercises.

However, Kuo failed to disclose that the supporting table includes a plurality of grooves formed therein, and further failed to disclose a massage member engaged with either of said grooves of said supporting table for attaching to said supporting table and for selectively engaging with the user to selectively massage the user.

U.S. Patent Application No. 2008/0086066 to Munday discloses a further typical inversion suspension exerciser comprising a massage device wherein massage members engage with grooves for attaching to the massage device and for selectively engaging with the user to selectively massage the user, and further teaches that the use of removable massage members allows for massage members of different sizes and shapes to be interchangeably attached in order to apply a desired amount of pressure to the user during the massage.

However, Munday failed to disclose that the supporting table includes a plurality of grooves formed therein, and a massage member engaged with either of said grooves of said supporting table, the massage device may not be acted or used as a supporting table attached to a carrier for supporting a user thereon, and the palm attachments, the muscle grabber attachments, and the thumb attachments may not be acted or used as a supporting table attached to a carrier for supporting a user thereon.

U.S. Patent Application No. 2004/0243037 to Zapalac et al. discloses a typical massage device comprising a plurality of massage members for engaging with and for massaging the user manually.

However, Zapalac et al. failed to disclose that a supporting table includes a plurality of grooves formed therein for engaging with massage members and for attaching to said supporting table and for selectively engaging with the user to selectively massage the user.

U.S. Patent Application No. 2005/0015031 to Lin discloses a further typical massage device comprising a plurality of rotatable massage members for engaging with and for massaging the user manually.

However, the massage members are solidly and stably secured and retained in a frame member and may not be easily moved to the other position or location of the frame member, and thus may not be used for massaging various portions of the user.

The present invention has arisen to mitigate and/or obviate the afore-described disadvantages of the conventional tilting inversion exercisers.

### SUMMARY OF THE INVENTION

The primary objective of the present invention is to provide a tilting inversion exerciser including a massage device or mechanism for massaging the back portions of the user in addition to the rotational exercises.

In accordance with one aspect of the invention, there is provided a tilting inversion exerciser comprising a supporting table including a plurality of grooves formed therein, and a massage member engaged with either of the grooves of the supporting table for attaching to the supporting table, the massage member including a block for engaging with the supporting table, and the massage member including a screw hole formed therein and aligned with either of the grooves of the supporting table, and a lock including a knob and a threaded shank extended from the knob for engaging through either of the grooves of the supporting table and for engaging with the screw hole of the block and for detachably securing the massage member to the supporting table, the knob of the lock including a length (L) greater than a width (W) of the grooves of the supporting table for allowing the knob of the lock to be engaged with the supporting table and to be anchored to the supporting table when the knob of the lock is rotated relative to the supporting table.

The massage member includes at least one projection extended from the knob for frictionally engaging with the supporting table. The supporting table includes a primary table plate and an auxiliary table plate attached to a carrier. The primary table plate and the auxiliary table plate each include a plurality of the grooves formed therein for engaging with the massage members and for attaching the massage members to the supporting table.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a tilting inversion exerciser in accordance with the present invention;

FIGS. 2, 3, 4 are perspective views similar to FIG. 1, illustrating the operation of the tilting inversion exerciser;

FIG. 5 is a partial perspective view of the supporting table;

FIG. 6 is a partial exploded view of the tilting inversion exerciser;

FIG. 7 is an exploded view illustrating a massage member of the tilting inversion exerciser;

FIGS. 8, 9 are bottom perspective views of the supporting table;

FIGS. 10, 11 are enlarged partial perspective views of the supporting table as shown in FIGS. 8 and 9 respectively;

FIG. 12 is a partial cross sectional view of the tilting inversion exerciser taken along lines 12-12 of FIG. 5;

FIG. 13 is another partial cross sectional view similar to FIG. 12, illustrating the operation of the tilting inversion exerciser; and

FIGS. 14, 15 are enlarged partial cross sectional views of the supporting table of the tilting inversion exerciser as shown in FIGS. 12, 13 respectively.

### DETAILED DESCRIPTION OF THE PREFERRED EMBODIMENT

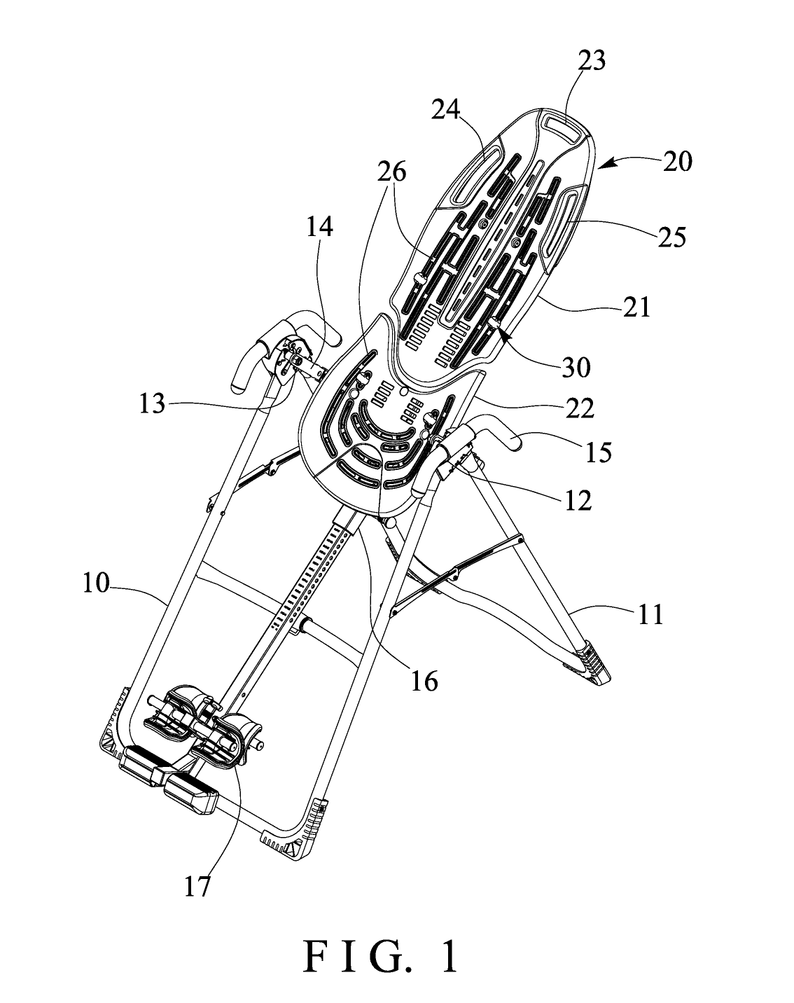

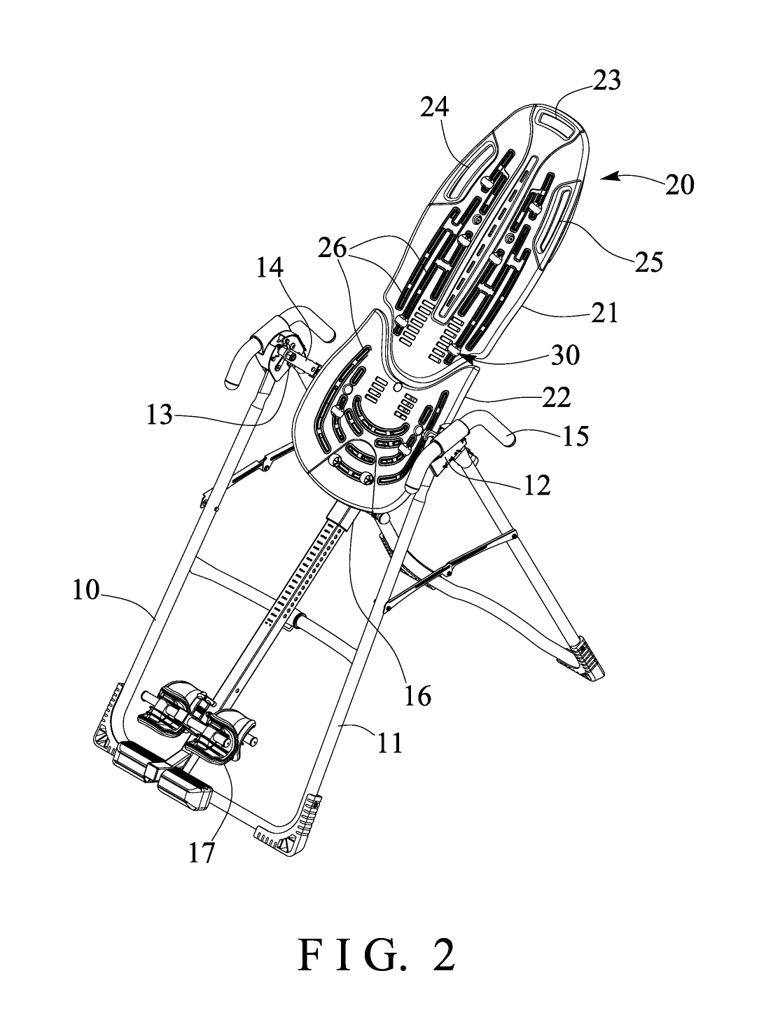

Referring to the drawings, and initially to FIGS. 1-4, a tilting inversion exerciser in accordance with the present invention comprises a lower supporting stand 10 for pivotally or rotatably supporting a base or table 20 thereon, and for supporting a user 8 on the supporting table 20 (FIGS. 3-4), the lower supporting stand 10 includes such as two U-shaped frames 11 having upper ends pivotally coupled together with two apex members 12 so as to form a substantially inverted V-shaped structure, and for allowing the frames 11 of the supporting stand 10 to be folded and supported between an opened working position (FIGS. 1-4) and a folded or compact storing position (not illustrated). The lower supporting stand 10 includes a joint or bearing support 13 and/or a U-shaped bracket or carrier 14 disposed or attached to each of the apex members 12 for pivotally or rotatably supporting or coupling the supporting table 20.

The lower supporting stand 10 includes one or more, such as two hand grips 15 formed or provided thereon, such as formed or provided on the apex members 12 respectively for being held or grasped or gripped by the user 8. The carrier 14 includes an extension 16, such as an adjustable extension 16 attached or coupled or extended from the lower portion thereof for supporting an ankle holder or foot retaining device 17 and for holding or retaining or positioning the feet of the user 8 to the carrier 14 and the supporting table 20. The extension 16 may be extended or adjusted relative to the supporting table 20 for moving or adjusting the foot retaining device 17 toward or away from the supporting table 20, according to the height of the user, for example. The above-described structure or configuration for the tilting inversion exerciser, including the lower supporting stand 10 and the carrier 14 and the hand grips 15 and the foot retaining device 17 is typical and is not related to the present invention and will not be described in further details.

The supporting table 20 may include two or more (such as two) table plates 21, 22, such as a primary table plate 21 and an auxiliary table plate 22 (FIGS. 1-6, 8-9) attached or mounted or secured to the carrier 14 for supporting the user 8 thereon, for example, the table plates 21, 22 may include different shapes or contours or configurations and may be made of different materials for comfortably supporting different portions of the user 8, for example, the primary table plate 21 may be made of softer or resilient materials for comfortably supporting the back or the upper portion of the user 8. The primary table plate 21 may further include one or more hand grips 23, 24, 25 formed or provided thereon for being held or grasped or gripped by the user 8 (FIGS. 3-4), particularly while conducting or operating the rotational or tilting inversion exercises.

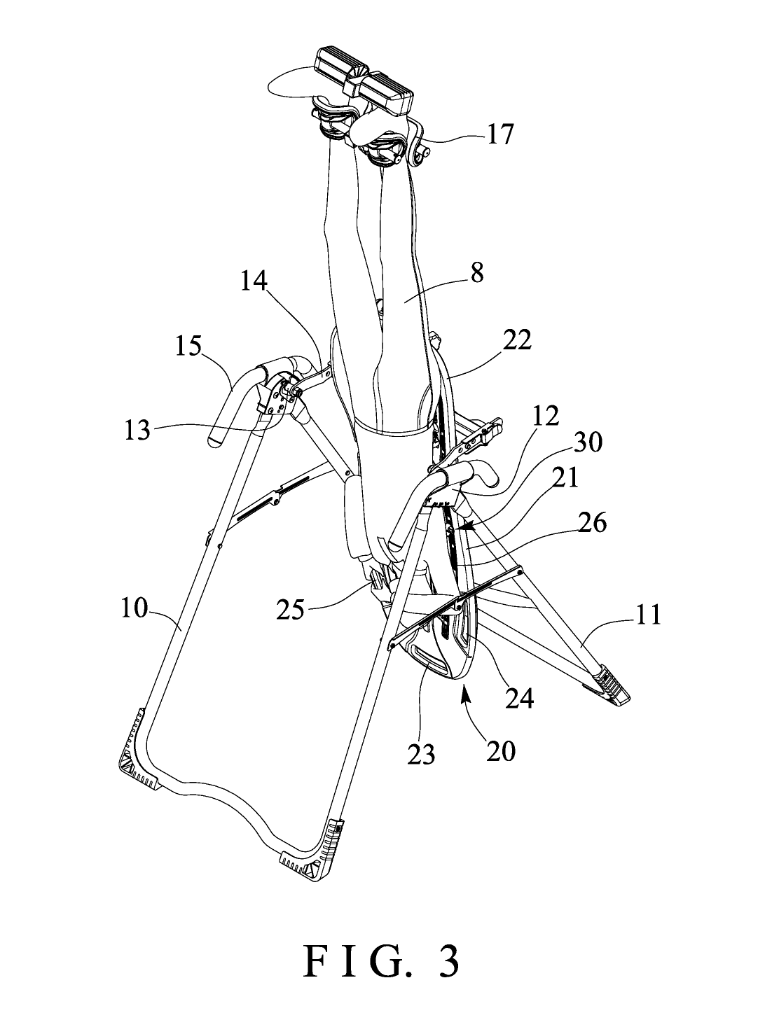

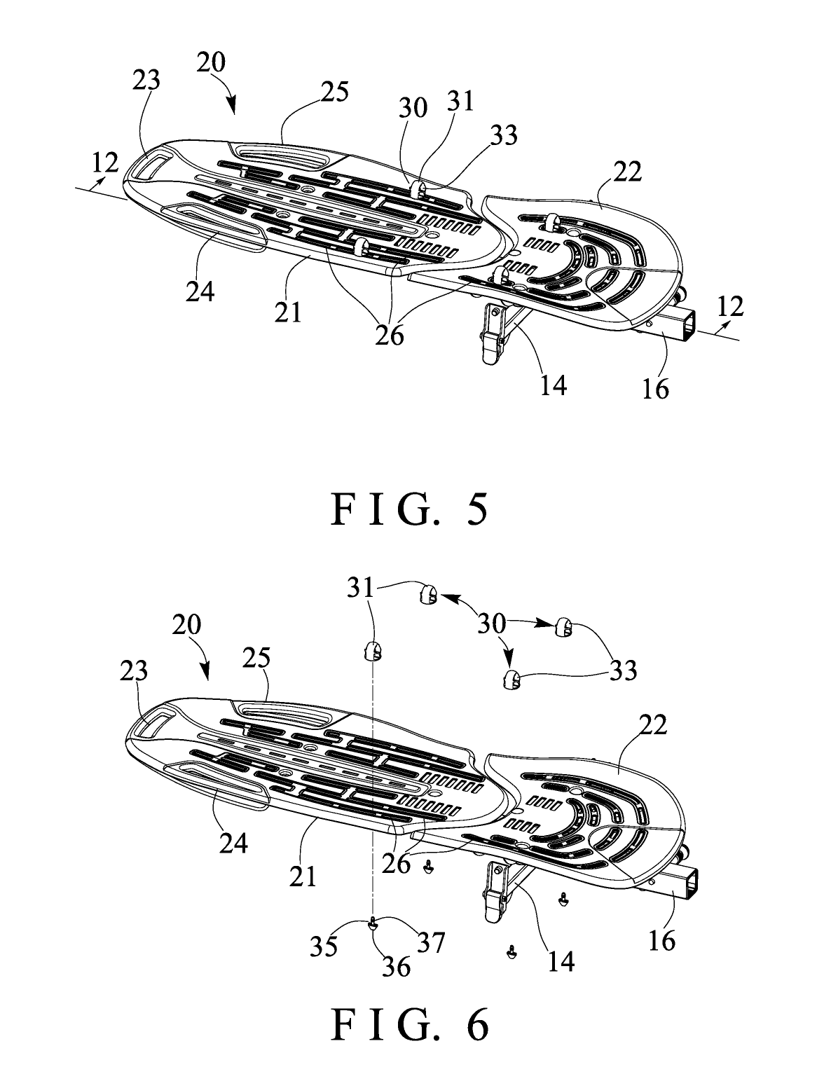

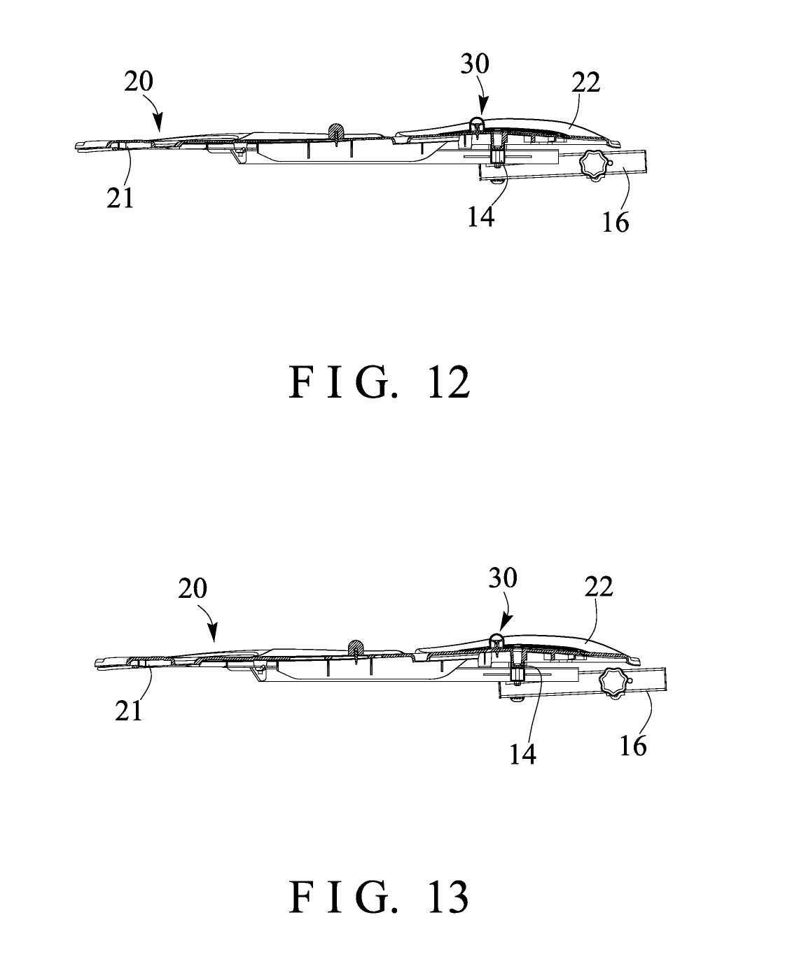

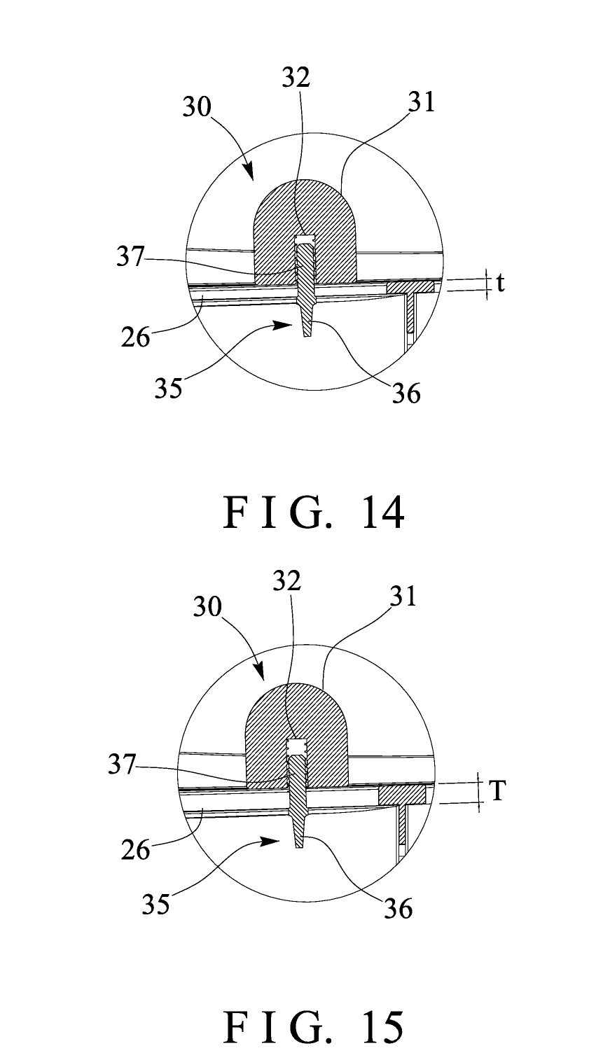

The supporting table 20 further includes a number of slots or channels or grooves 26 formed or provided in either or both of the table plates 21, 22 for attaching or mounting or securing one or more massage devices or members 30 to either or both of the table plates 21, 22. As shown in FIGS. 1-15, the massage members 30 each include a rounded body member or block 31 for attaching or engaging with and/or onto the supporting table 20, and the massage members 30 each include an inner thread or screw hole 32 formed therein (FIGS. 7 and 14-15) and aligned with or communicating with the grooves 26 of the table plates 21, 22 (FIGS. 14-15), and the massage members 30 each include one or more notches or recesses 33 formed therein (FIGS. 5-7) for increasing the softness or the resilience of the massage members 30 and for allowing the block 31 of the massage member 30 to be easily and effectively and frictionally rotated by the user.

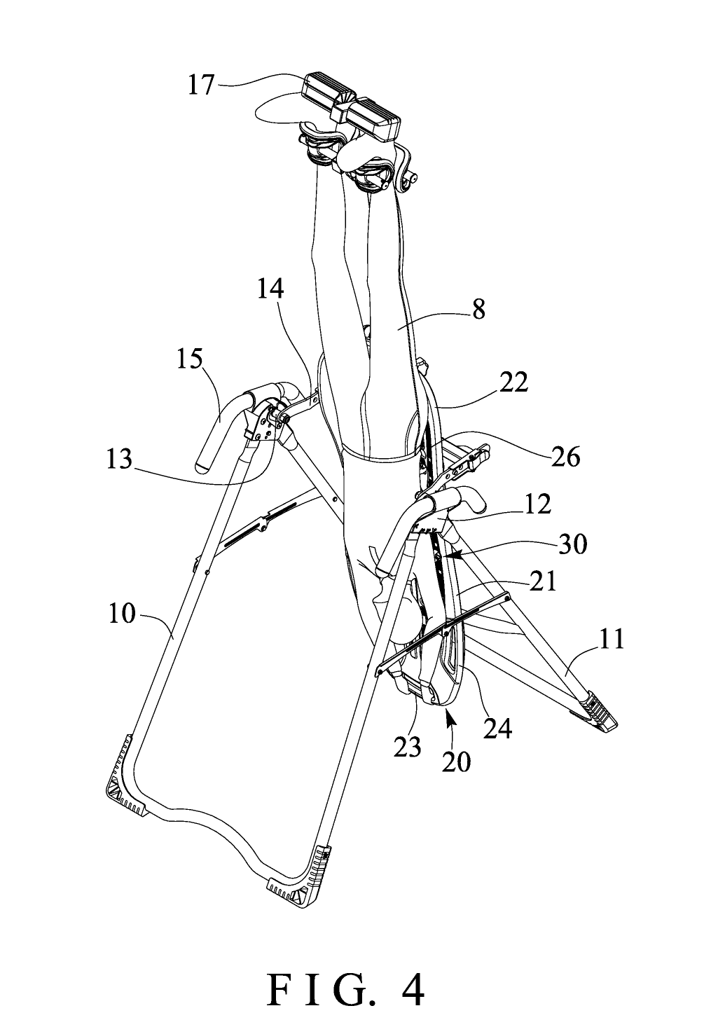

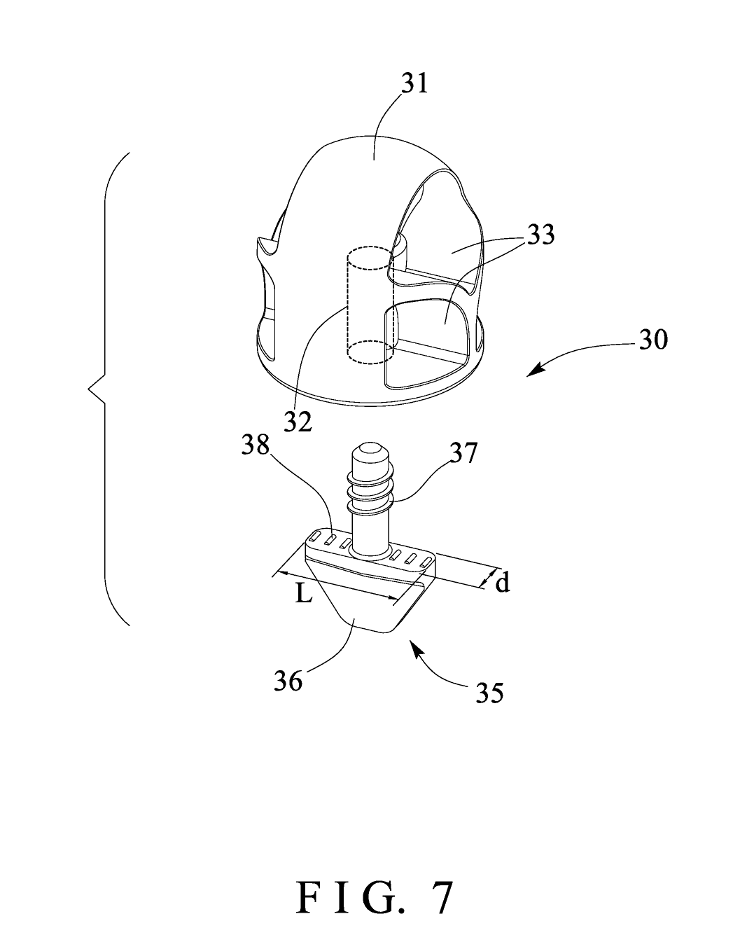

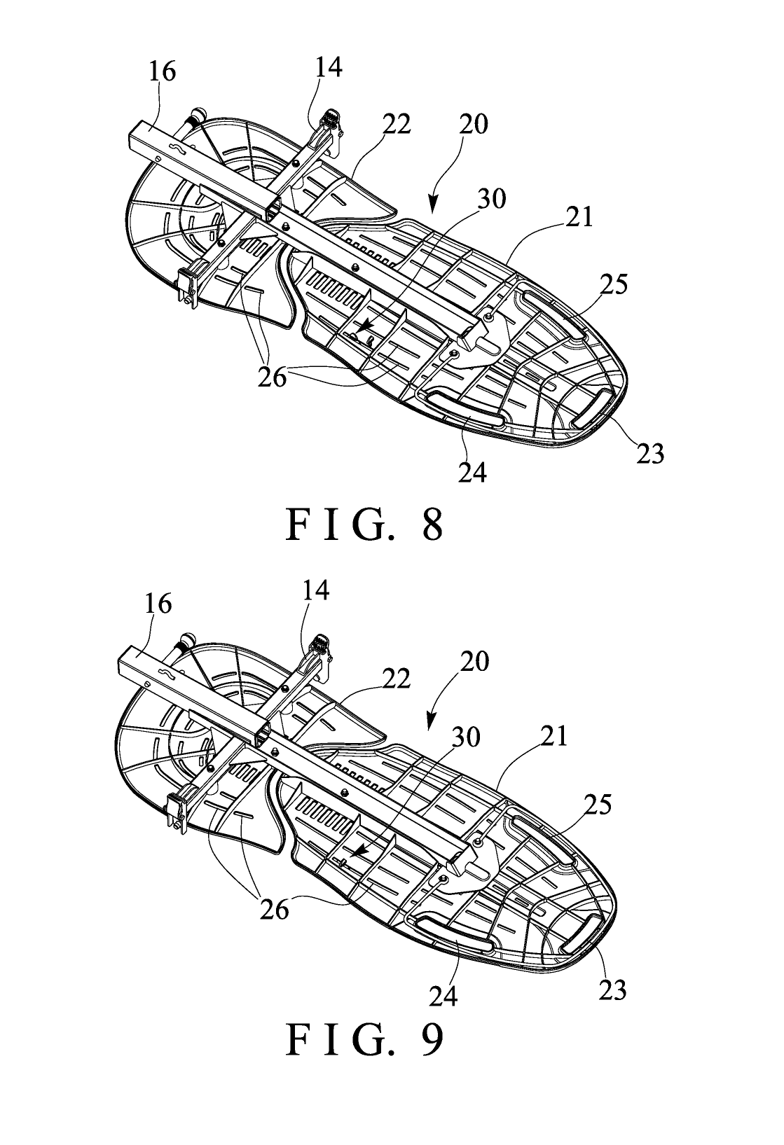

The massage members 30 each further include a fastener or catch or lock 35 having a wing or knob 36, and a threaded shank 37 extended outwardly from the knob 36 (FIGS. 6-7, 10-11, 14-15) for engaging through the grooves 26 of the table plates 21, 22 and for threading or engaging with the screw hole 32 of the block 31 and for detachably or removably attaching or mounting or securing the massage members 30 to the table plates 21, 22 of the supporting table 20. The knob 36 and/or the threaded shank 37 include a thickness or width (d, FIGS. 7 and 10-11) smaller than or no greater than the width (W) of the grooves 26 of the table plates 21, 22 for allowing the knob 36 and the threaded shank 37 of the lock 35 to be engaged into or through the grooves 26 of the table plates 21, 22 (FIGS. 8 and 10).

The length (L) of the knob 36 of the lock 35 (FIGS. 7, 11) is greater than the width (W) of the grooves 26 of the table plates 21, 22 for allowing the knob 36 of the lock 35 to be engaged with the table plates 21, 22 and to be anchored or secured or retained to the table plates 21, 22 when the knob 36 of the lock 35 is rotated for about ninety (90) degrees relative to the table plates 21, 22 (FIGS. 9 and 11). It is preferable that the massage members 30 each include one or more projections 38 extended outwardly therefrom (FIG. 7) for selectively and frictionally engaging with the table plates 21, 22 and for solidly and stably anchoring or securing or retaining the massage members 30 to the table plates 21, 22. The massage members 30 may be easily and quickly and readily attached or mounted or secured to various locations of the table plates 21, 22 for engaging with and for comfortably massaging various portions of the user 8, particularly while conducting or operating the rotational or tilting inversion exercises.

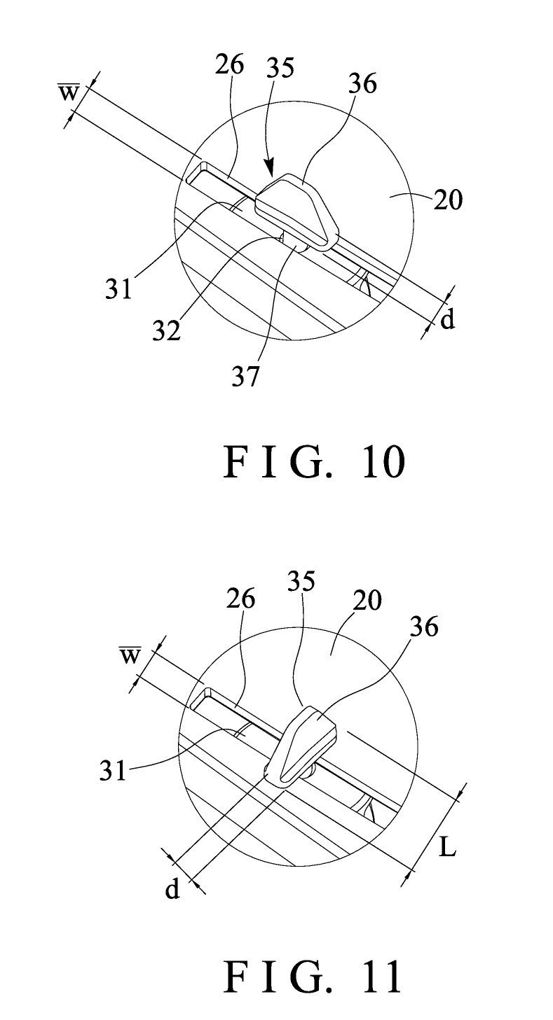

In operation, as shown in FIGS. 6, 8 and 10, the massage members 30 may be easily and quickly and readily attached or mounted or secured to various locations of the table plates 21, 22 by engaging or inserting the threaded shank 37 of the lock 35 into or through the grooves 26 of the table plates 21, 22, and threading or engaging with the screw hole 32 of the block 31, and when the lock 35 is rotated for about ninety (90) degrees relative to the table plates 21, 22, best shown in FIGS. 9 and 11, the lock 35 may be engaged with the table plates 21, 22, and the massage member 30 may be anchored or secured or retained to the table plates 21, 22 for engaging with and for comfortably massaging various portions of the user 8. As shown in FIGS. 12-15, the blocks 31 of the massage members 30 may be attached or mounted or secured to the table plates 21, 22 of the supporting table 20 of different standards or thicknesses (t, T).

Accordingly, the tilting inversion exerciser in accordance with the present invention includes a massage device or mechanism for massaging the back portions of the user in addition to the rotational exercises.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A tilting inversion exerciser comprising:
a supporting table including a plurality of grooves formed therein, and
a massage member engaged with either of said grooves of said supporting table for attaching to said supporting table, said massage member including a block for engaging with said supporting table, and said massage member including a screw hole formed therein and aligned with either of said grooves of said supporting table, and a lock including a knob and a threaded shank extended from said knob for engaging through either of said grooves of said supporting table and for engaging with said screw hole of said block and for detachably securing said massage member to said supporting table, said knob of said lock including a length (L) greater than a width (W) of said grooves of said supporting table for allowing said knob of said lock to be engaged with said supporting table and to be anchored to said supporting table when said knob of said lock is rotated relative to said supporting table.

2. The tilting inversion exerciser as claimed in claim 1, wherein said massage member includes at least one projection extended from said knob for engaging with said supporting table.

3. The tilting inversion exerciser as claimed in claim 1, wherein said supporting table includes a primary table plate and an auxiliary table plate attached to a carrier.

4. The tilting inversion exerciser as claimed in claim 3, wherein said primary table plate and said auxiliary table plate each include a plurality of said grooves formed therein.
